(19) United States
(12) Patent Application Publication
(10) Pub. No.: US 2026/0040151 A1
(43) Pub. Date: Feb. 5, 2026

(54) EXTENDING HANDS-FREE RANGE WITH DYNAMIC DATA RATES

(71) Applicant: Silicon Laboratories Inc., Austin, TX (US)

(72) Inventors: Jitesh Rachamadugu, Hyderabad (IN); Suresh Babu Sykam, Hyderabad (IN); Ayan Bandhu Ghosh, Hyderabad (IN); Sandeep Voruganti, Hyderabad (IN); Niranjan Kumar Jonnada, Hyderabad (IN)

(21) Appl. No.: 18/789,298

(22) Filed: Jul. 30, 2024

(51) Int. Cl. H04W 28/22; H04L 1/18; H04W 28/02; H04W 76/18

(52) U.S. Cl. CPC H04W 28/22; H04L 1/18; H04W 28/0215; H04W 76/18

(57) ABSTRACT

In one embodiment, a method includes: requesting, via a first device, a synchronous connection to be established between the first device and a second device wirelessly coupled to the first device; negotiating, with the second device, parameters of the synchronous connection, the parameters including at least one dynamic data rate switching parameter; and configuring a transceiver of the first device to operate with dynamic data rate switching based at least in part on the at least one dynamic data rate switching parameter.

### BACKGROUND

In certain situations, cell phone users want to communicate in a hands-free mode such as when driving a vehicle or otherwise on the go. To effect this operation, there is a short-range wireless communication (e.g., Bluetooth) between another device and the cell phone, and in turn the cell phone communicates with a cellular network.

Sometimes, particularly as distance between the device and cell phone increases, call quality can become diminished. While there are mechanisms to retransmit packets that are not successfully received, there may still be packet loss if the retransmission is not successful. Such concerns increase as range and/or communication rate increases, and/or power consumption decreases.

### SUMMARY OF THE INVENTION

In one aspect, a method includes: requesting, via a first device, a synchronous connection to be established between the first device and a second device wirelessly coupled to the first device; negotiating, with the second device, parameters of the synchronous connection, the parameters including at least one dynamic data rate switching parameter; and configuring a transceiver of the first device to operate with dynamic data rate switching based at least in part on the at least one dynamic data rate switching parameter.

In an implementation, negotiating the at least one dynamic data rate switching parameter comprises negotiating: a first primary data rate from the first device to the second device; a second primary data rate from the second device to the first device; a first secondary data rate from the first device to the second device, wherein the first secondary data rate is less than the first primary data rate; and a second secondary data rate from the second device to the first device, the second secondary data rate less than the first secondary data rate. The method may further include: sending, via the transceiver of the first device, to the second device a packet comprising message data during a reserved window of a first communication interval at the first primary data rate; and receiving, via the transceiver of the first device, a response to the packet during the reserved window of the first communication interval. Also, the method may further include: when the response indicates that second device successfully received the packet, sending, via the transceiver of the first device, to the second device a second packet comprising second message data during a reserved window of a second communication interval at the first primary data rate; and when the response indicates that the second device did not successfully receive the packet, retransmitting, via the transceiver, the packet to the second device during a retransmission window of the first communication interval at the first secondary data rate.

In an implementation, the method further comprises negotiating a common data rate for the first primary data rate and the second primary data rate. Configuring the transceiver of the first device to operate with the dynamic data rate switching causes the transceiver to: send, to the second device, a packet comprising message data during a reserved window of a communication interval at the first primary data rate; and in response to an indication that the second device did not successfully receive the packet, retransmit the packet to the second device during a retransmission window of the communication interval at the first secondary data rate. The method may also include: sending, via the transceiver of the first device, to the second device the packet during the reserved window of the communication interval at the first primary data rate; and in response to the indication that the second device did not successfully receive the packet, retransmitting, via the transceiver of the first device, the packet to the second device during the retransmission window of the communication interval at the first secondary data rate. The method may further comprise: in response to an indication that the second device did not successfully receive the retransmitted packet, retransmitting, via the transceiver of the first device, the packet to the second device during a second reserved window of the communication interval at the first primary data rate.

In an implementation, negotiating, with the second device, comprises receiving an acknowledgement from the second device to indicate that the second device is capable of the dynamic data rate switching. In response to an indication that the second device is not capable of the dynamic data rate switching, the transceiver of the first device is not configured to operate with the dynamic data rate switching, and is configured to operate at a static data rate. The method may also include receiving a message comprising a dynamic switching mode disable indication from the second device, the dynamic switching mode disable indication comprising the indication that the second device is not capable of the dynamic data rate switching.

In another aspect, a wireless device comprises: at least one transceiver to transmit and receive radio frequency (RF) signals; a baseband processor coupled to the at least one transceiver to process baseband signals and to operate a link manager of a logical link layer. The link manager is to: request a synchronous connection to be established between the wireless device and a second wireless device; negotiate, with the second wireless device, parameters of the synchronous connection, the parameters comprising at least one dynamic data rate switching parameter; and configure the at least one transceiver to operate with dynamic data rate switching based at least in part on the at least one dynamic data rate switching parameter. The wireless device may include a non-volatile memory coupled to the baseband processor to store code of the logical link layer.

In an implementation, the link manager is to send an extended synchronous connection oriented (eSCO) request to request the synchronous connection. The link manager may be configured to negotiate the at least one dynamic data rate switching parameter comprising: a first primary data rate from the wireless device to the second wireless device; a second primary data rate from the second wireless device to the wireless device; a first secondary data rate from the wireless device to the second wireless device, wherein the first secondary data rate is less than the first primary data rate; and a second secondary data rate from the second wireless device to the wireless device, the second secondary data rate less than the first secondary data rate.

In an implementation, the at least one transceiver is to: send, to the second wireless device, a packet comprising message data during a reserved window of a first communication interval at the first primary data rate; and receive, from the second wireless device, a response to the packet during the reserved window of the first communication interval. The at least one transceiver may further: when the response indicates that second wireless device successfully received the packet, send, to the second wireless device, a second packet comprising second message data during a reserved window of a second communication interval at the first primary data rate; and when the response indicates that the second wireless device did not successfully receive the packet, retransmit, to the second wireless device, the packet during a retransmission window of the first communication interval at the first secondary data rate.

In yet another aspect, a non-transitory storage medium stores instructions that when executed cause a first wireless device to perform a method comprising: requesting a synchronous connection to be established between the first wireless device and a second wireless device; negotiating, with the second wireless device, parameters of the synchronous connection, the parameters comprising at least one dynamic data rate switching parameter; and configuring a transceiver of the first wireless device to operate with dynamic data rate switching based at least in part on the at least one dynamic data rate switching parameter.

In an implementation, negotiating the at least one dynamic data rate switching parameter comprises negotiating: a first primary data rate from the first wireless device to the second wireless device; a second primary data rate from the second wireless device to the first wireless device; a first secondary data rate from the first wireless device to the second wireless device, wherein the first secondary data rate is less than the first primary data rate; and a second secondary data rate from the second wireless device to the first wireless device, the second secondary data rate less than the first secondary data rate.

In an implementation, the method further comprises: sending, via the transceiver of the first wireless device, to the second wireless device a packet comprising message data during a reserved window of a first communication interval at the first primary data rate; and receiving, via the transceiver of the first wireless device, a response to the packet during the reserved window of the first communication interval. The method further comprises: negotiating, with a third wireless device, parameters of another synchronous connection comprising a static data rate when the third wireless device does not support the dynamic data rate switching; and configuring the transceiver of the first wireless device to operate with the static data rate when communicating with the third wireless device.

### BRIEF DESCRIPTION OF THE DRAWINGS

FIG. 1 is a block diagram of a wireless environment in accordance with an embodiment.

FIG. 2 is a flow diagram of a method in accordance with an embodiment.

FIG. 3 is a timing diagram illustrating a negotiation process in accordance with an embodiment.

FIG. 4 is a flow diagram of a method in accordance with another embodiment.

FIG. 5 is a timing diagram illustrating a wireless communication in accordance with an embodiment.

FIG. 6 is a block diagram of a representative integrated circuit in accordance with an embodiment.

### DETAILED DESCRIPTION

In various embodiments, wireless devices are configured to communicate in a hands-free mode, e.g., for cellphone calls or other voice data. During this hands-free mode of operation, the wireless devices can be configured to operate with dynamic data rate switching capabilities. With these capabilities, the devices may accurately communicate over wider ranges, with lower power consumption and reduced need for retransmissions. Although embodiments are described herein in the context of a hands-free mode to enable cellular communications, understand that embodiments are not limited in this regard, nor are they limited to the Bluetooth extended synchronous (eSCO) data communications described herein. Furthermore, while illustrated implementations regard hands-free communication realized via a Bluetooth connection between a smartphone and another device, such as a headset, vehicle communication system or so forth, other devices may communicate voice or other synchronous data using the techniques described herein.

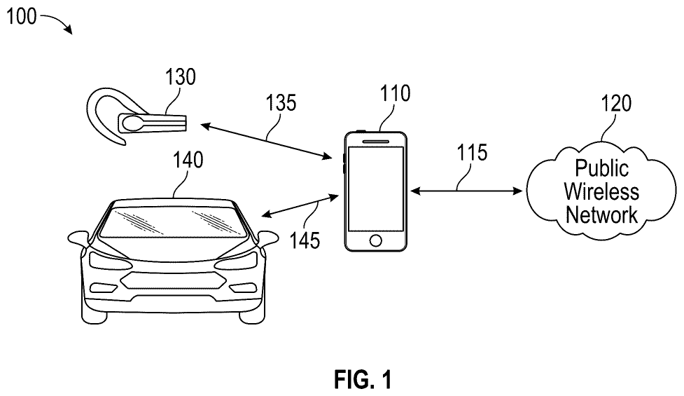

Referring now to FIG. 1, shown is a block diagram of a wireless environment in accordance with an embodiment. More specifically, FIG. 1 illustrates possible devices that may communicate wirelessly using techniques for variable data rate transmissions as described herein. In the context of FIG. 1, environment 100 includes a mobile phone 110. In embodiments, mobile phone 110 can be a smartphone having one or more wireless transceivers that can communicate according to multiple communication protocols, including at least a Wi-Fi protocol and one or more Bluetooth protocols, and also via a cellular protocol.

Thus as shown, mobile device 110 can make and receive voice calls via a public wireless network 120, to which it is coupled via a cellular connection 115. In addition, mobile phone 110 can communicate with devices in a local area via one or more other wireless protocols. For purposes of discussion, assume that mobile phone 110 communicates with a headset 130 and a hands-free unit 140 of a vehicle via at least corresponding Bluetooth connections 135, 145.

To enable hands-free communications, the various devices may implement a hands-free profile that is used to enable voice calls via headset 130 and/or hands-free unit 140, and through mobile phone 110 to wireless network 120. Such hands-free communications may occur using eSCO logical links as described herein. With this arrangement, a user can make hands-free calls via one or more of headset 130 and hands-free unit 140. And with embodiments, the user may be in a more distant range from mobile phone 110, and still successfully make and receive calls when Bluetooth communications occur with dynamic data rate switching as described herein. Although shown at this high level in the embodiment of FIG. 1, understand that mobile phone 110 may communicate wirelessly, e.g., via Bluetooth communications with other devices to enable hands-free communication with dynamic data rates as described herein.

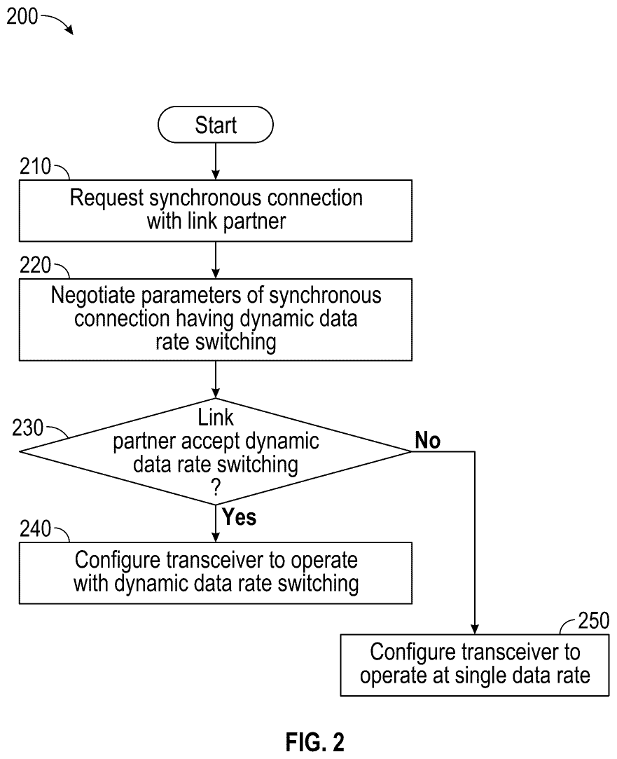

Referring now to FIG. 2, shown is a flow diagram of a method in accordance with an embodiment. More specifically, FIG. 2 illustrates a method 200 for negotiating and configuring communicating devices to operate with dynamic data rate switching capabilities as described herein. As such, method 200 may be performed by a wireless device such as a given initiator device. Depending upon direction of a call, the initiating device can be earphones, headset, vehicle system or other wireless device in communication with a cellphone such as a smartphone (or the smartphone can be the initiating device in the case of an incoming call). In this example, the smartphone acts as a link partner to enable voice data to be communicated over a cellular network. As such, method 200 can be performed by hardware circuitry of the wireless device alone and/or in combination with firmware and/or software.

As illustrated, method 200 begins by requesting a synchronous connection with a link partner (block 210). In embodiments, a link manager of the device, such as implemented using an Asynchronous Connection Less (ACL) logical link, can be used to request this synchronous connection. In an embodiment, this request may, in an illustrative Bluetooth implementation, be sent from a link manager of the initiating device, which may be assumed to be a master device, to a link manager of the link partner device, which may be assumed to be a slave device.

Still referring to FIG. 2, next at block 220, parameters of the synchronous connection may be negotiated between the devices. To this end, various parameters can be advertised to indicate each device's capabilities and negotiated to an agreed set of parameters. While exemplary parameters are discussed below, for purposes of the dynamic data rate switching, these negotiated parameters include at least one dynamic data rate switching parameter. As will be described further, this parameter may actually be a set of parameters to identify negotiated data rates from master to slave and vice versa, both for a higher data rate, referred to herein as a primary data rate, and a lower data rate, referred to herein as a secondary data rate. Although implementations described herein provide for two different data rates, understand that embodiments are not limited in this regard and in other implementations, more than two data rates may be provided for the dynamic data rate switching.

With further reference to FIG. 2, at diamond 230, it is determined whether the link partner accepts the dynamic data rate switching. If so, at block 240, the link master may configure a transceiver of the wireless device to operate with dynamic data rate switching. As part of this configuration, the transceiver may be provided with configuration parameters, including identification of the primary and secondary data rates, both in the transmit and receive directions.

Otherwise, if the link partner does not accept the dynamic data rate switching, which may be indicated in an embodiment by a non-acceptance (e.g., an LMP_NOT_ACCEPT_EXT PDU), control passes to block 250, where the transceiver is configured to operate at a single data rate. In this case, the transceiver may be configured with a single data rate for transmission and a single data rate for reception. Although shown at this high level in the embodiment of FIG. 2, understand that many variations and alternatives are possible.

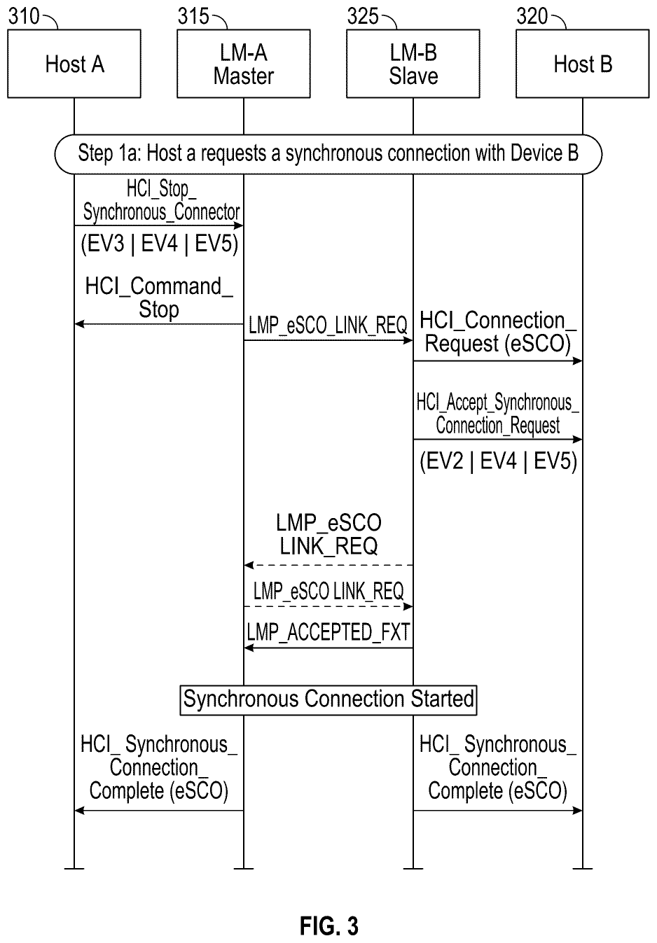

Referring now to FIG. 3, shown is a timing diagram illustrating a negotiation process in accordance with an embodiment. As shown in FIG. 3, a host 310 communicates with another host 320. In the illustration shown, host 310 is implemented as a master device and includes a first link master (LM-A) 315, which acts as a master. In turn, host 320 is implemented as a slave device and includes a second link master (LM-B) 325, which acts as a slave. As shown, various messages are communicated between the corresponding host and slave LMs of the devices. As seen, higher layers communicate a setup request for a synchronous connection with first LM 315, which provides a status back to host 310 and also sends the synchronous connection request to second LM 325, which in turn, provides an eSCO connection request to higher layers of host 320.

In this example, assume that host 320 accepts (via an accept synchronous connection request) the synchronous communication. Thus second LM 325 sends an eSCO link request, and various communications occur between the two LMs to negotiate parameters, including the dynamic data rates described herein.

Referring now to Table 1, shown is a listing of example synchronous link parameters in accordance with an embodiment.

TABLE 1

| | |
|---|---|
| Header | |
| Transaction ID | Initiated by Central |
| OpCode | LMP_eSCO_link_req_ext |
| Payload | |
| eSCO Handle | 0x0A |
| eSCO LT_ADDR | 3 |
| Timing Control Flags | No Timing Change, Use Initialization |
| | 1, Access Window |
| DeSCO | 6 slots = 3.750 ms |
| TeSCO | 13 slots - 7.500 ms |
| WeSCO | 4 slots = 2.500 ms |
| Prim. Packet Type M−>S | 2-EV3 |
| Prim. Packet Type S−>M | 2-EV3 |
| Prim. Packet Length M−>S | 60 bytes |
| Prim. Packet Length S−>M | 60 bytes |
| Sec. Packet Type M−>S | EV3 (60 bytes) |
| Sec. Packet Type S−>M | EV3 (60 bytes) |
| Sec. Packet Length M−>S | 60 bytes |
| Sec. Packet Length S−>M | 60 bytes |
| Air Mode | Transparent Data |
| Negotiate State | 0x00 |

As shown in Table 1, the parameters include primary and secondary packet types (which identify the primary and secondary data rates and packet lengths). And as shown in Table 2, the packet types map to different transmission data rates, with the packet type parameters listed (e.g., header size, payload size, error correction coding (FEC), message integrity coding (MIC), checksum (CRC) and rate information).

TABLE 2

| | | | | | | | Trans- |
|---|---|---|---|---|---|---|---|
| | Payload | User | | | | Symmetric | mission |
| | Header | Payload | | | | Max. Rate | Rate |
| Type | (bytes) | (bytes) | FEC | MIC | CRC | (kb/s) | (Mb/s) |
| EV3 | N/A | 1-30 | No | No | Yes | 96 | 1 |
| EV4 | N/A | 1-120 | 2/3 | No | Yes | 192 | 1 |
| EV5 | N/A | 1-180 | No | No | Yes | 288 | 1 |
| 2-EV3 | N/A | 1-60 | No | No | Yes | 192 | 2 |
| 2-EV5 | N/A | 1-360 | No | No | Yes | 576 | 2 |
| 3-EV3 | N/A | 1-90 | No | No | Yes | 288 | 3 |
| 3-EV5 | N/A | 1-540 | No | No | Yes | 864 | 3 |

Still referring to FIG. 3, a resulting synchronous connection is established and is started at block 350. Thereafter, communications may occur according to the negotiated dynamic data rates.

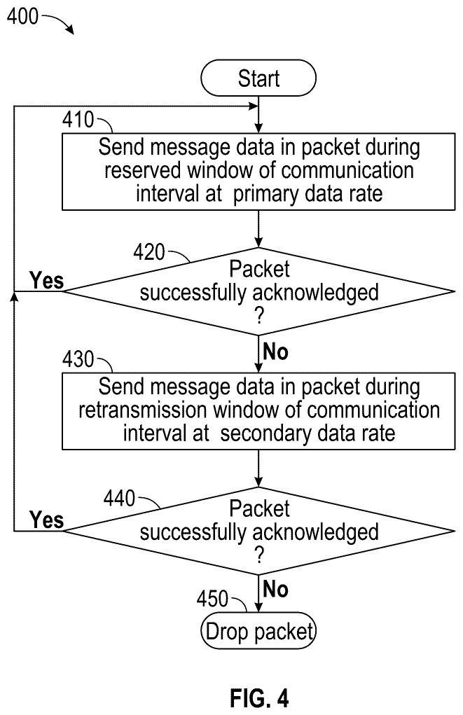

Referring now to FIG. 4, shown is a flow diagram of a method in accordance with another embodiment. More specifically, method 400 is a method for communicating synchronous data between wireless devices using the dynamic data rates described herein. Method 400 can be performed by hardware circuitry of the wireless device alone and/or in combination with firmware and/or software, which operates to cause a transceiver of the device to send packets at one or more data rates.

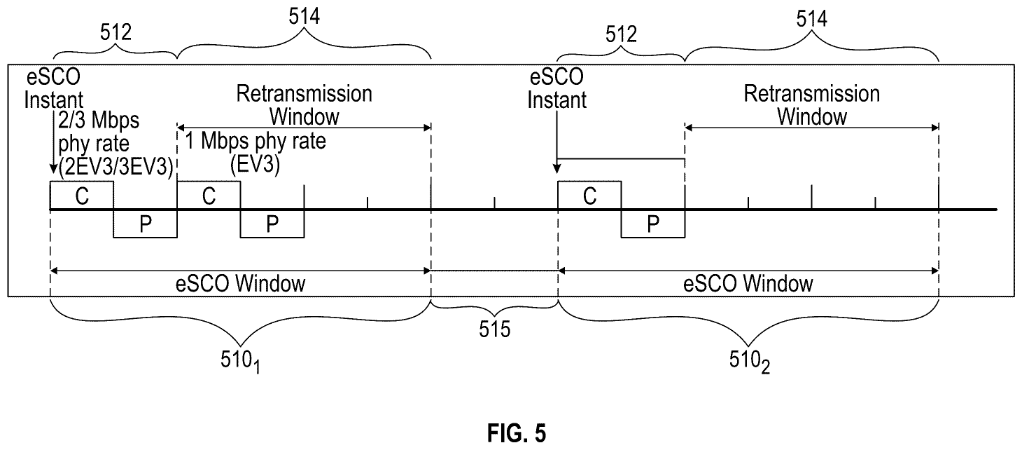

As shown, method 400 begins by sending message data in a packet from the first device to the second device (block 410) This packet communication, which may be at the primary data rate negotiated for this direction of communication, is sent during a reserved window of a communication interval, as will be described further with regard to FIG. 5 below. Assume for purposes of discussion that the message data is voice data. Next, it is determined at diamond 420 whether the packet is successfully acknowledged. This acknowledgment may be achieved via receipt in the first device of a success acknowledgement from the second device during the reserved window. If successfully received, control passes back to block 410 where message data of another packet is sent, e.g., during a next communication interval.

Still referring to FIG. 4, instead if it is determined that the first packet was not successfully acknowledged, control passes to block 430 where the message data is sent in a retransmitted packet. However in this instance, the packet is sent during a retransmission window of the communication interval, and it is sent at the secondary data rate. As discussed above, this secondary data rate is at a lower rate, thus better ensuring the chance that the packet is successfully received. As an example, the secondary data rate may be at a rate of 1 Megabit per second (Mbps).

Control passes next to diamond 440 where it is determined whether this retransmitted packet is successfully acknowledged. If so, control passes back to block 410 for transmission of additional message data in another packet. Otherwise, if it is determined that the retransmitted packet is not successfully acknowledged, control passes to block 450, where the packet is dropped. In some implementations, in this case higher layers may initiate a packet loss concealment (PLC). Although shown at this high level in the embodiment of FIG. 4, many variations and alternatives are possible.

Referring now to FIG. 5, shown is a timing diagram illustrating a wireless communication in accordance with an embodiment. As shown in FIG. 5, in timing diagram 500 there are a plurality of communication intervals 510. Each communication interval 510 includes a reserved window 512 and a retransmission window 514. While in the embodiment shown, reserved windows 512 have a smaller width than retransmission windows 514, embodiments are not limited in this aspect. As further illustrated, a null period 515 is present between each communication interval.

In FIG. 5, during a first portion of a reserved slot 512, a forward transmission is sent (denoted with a ‘C’ indicating a transmission from central device). This transmission is sent at the negotiated first primary rate to transmit the packet (which may be formed of one or more slots) at high speed. Thereafter, but still within reserved window 512, the receiving device sends an acknowledgement back (denoted with a ‘P’ indicating a transmission from peripheral device). When successfully received, the receiving device sends a positive acknowledgement to indicate successful receipt, and instead, when not correctly received, it sends a negative acknowledgment (e.g., a NAK).

In the instance where the receiving device does not successfully receive the transmitted packet, the transmitter sends a retransmission of the packet during retransmission window 514. With embodiments, understand that this retransmission of the packet occurs at a lower data rate, namely, the first secondary data rate (e.g., which may be at 1 Mbps). In turn, the receiving device sends an acknowledgment, also at a lower data rate to indicate whether it successfully receives the packet.

As further illustrated in FIG. 5, note that during second communication interval 510₂, a successful receipt of the packet sent at the primary data rate is acknowledged, and thus there is no transmission that occurs during retransmission window 514 of second communication interval 510₂. Of course, different window sizes and transmission patterns may occur in other embodiments.

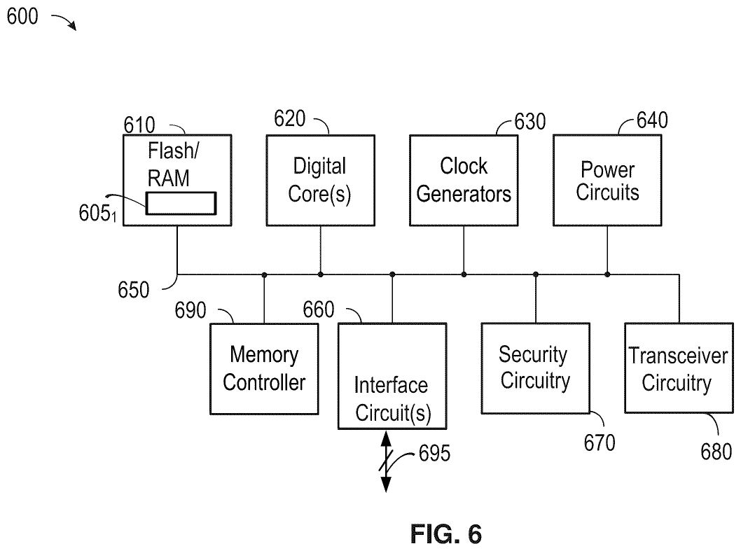

Embodiments can be implemented in a variety of wireless device use cases. Referring now to FIG. 6, shown is a block diagram of a representative integrated circuit 600 that includes transceiver circuitry, as described herein. In the embodiment shown in FIG. 6, integrated circuit 600 may be, e.g., a multi-mode wireless transceiver that may operate according to one or more wireless protocols (e.g., Wi-Fi and Bluetooth, among others) or other device that can be used in a variety of use cases. In one or more embodiments, the circuitry of integrated circuit 600 shown in FIG. 6 may be implemented on a single semiconductor die or implemented on separate dies for wireless communication.

Integrated circuit 600 may be included in a range of devices, but for purposes of discussion, it may be incorporated into a headset, vehicle infotainment system or other system such as shown in FIG. 1. In the embodiment shown, integrated circuit 600 includes a memory system 610 which in an embodiment may include volatile storage, such as RAM and non-volatile memory such as a flash memory. The flash memory is a non-transitory storage medium that can store instructions and data. In embodiments, this storage may store a link manager 605₁ that can enable and configure the device for dynamic data rate synchronous communication, as described herein. As further shown integrated circuit 600 also may include a memory controller 690.

Memory system 610 couples via a bus 650 to one or more digital cores 620, which may include one or more cores and/or microcontrollers that act as processing units of the integrated circuit, and which may execute link manager operations. In turn, digital cores 620 may couple to clock generators 630 which may provide one or more phase locked loops or other clock generator circuitry to generate various clocks for use by circuitry of the IC.

As further illustrated, IC 600 further includes power circuitry 640. Additional circuitry may be present depending on particular implementation to provide various functionality and interaction with external devices. Such circuitry may include interface circuitry 660 which provides a digital communication interface with additional circuitry. IC 600 also may include security circuitry 670 to perform wireless security techniques.

In addition, as shown in FIG. 6, transceiver circuitry 680 may be provided to enable transmission and reception of wireless signals, e.g., according to one or more of a local area or wide area wireless communication scheme, such as Zigbee, Bluetooth, IEEE 802.11, IEEE 802.15.4, cellular communication or so forth. Transceiver circuitry 680 may communicate synchronous data at dynamic data rates as described herein. Understand while shown with this high level view, many variations and alternatives are possible.

While the present disclosure has been described with respect to a limited number of implementations, those skilled in the art, having the benefit of this disclosure, will appreciate numerous modifications and variations therefrom. It is intended that the appended claims cover all such modifications and variations.

What is claimed is:

1. A method comprising:
requesting, via a first device, a synchronous connection to be established between the first device and a second device wirelessly coupled to the first device;
negotiating, with the second device, parameters of the synchronous connection, the parameters comprising at least one dynamic data rate switching parameter; and
configuring a transceiver of the first device to operate with dynamic data rate switching based at least in part on the at least one dynamic data rate switching parameter.

2. The method of claim 1, wherein negotiating the at least one dynamic data rate switching parameter comprises negotiating:
a first primary data rate from the first device to the second device;
a second primary data rate from the second device to the first device;
a first secondary data rate from the first device to the second device, wherein the first secondary data rate is less than the first primary data rate; and
a second secondary data rate from the second device to the first device, the second secondary data rate less than the first secondary data rate.

3. The method of claim 2, further comprising:
sending, via the transceiver of the first device, to the second device a packet comprising message data during a reserved window of a first communication interval at the first primary data rate; and
receiving, via the transceiver of the first device, a response to the packet during the reserved window of the first communication interval.

4. The method of claim 3, further comprising:
when the response indicates that second device successfully received the packet, sending, via the transceiver of the first device, to the second device a second packet comprising second message data during a reserved window of a second communication interval at the first primary data rate; and
when the response indicates that the second device did not successfully receive the packet, retransmitting, via the transceiver, the packet to the second device during a retransmission window of the first communication interval at the first secondary data rate.

5. The method of claim 2, further comprising negotiating a common data rate for the first primary data rate and the second primary data rate.

6. The method of claim 2, wherein configuring the transceiver of the first device to operate with the dynamic data rate switching causes the transceiver to:
send, to the second device, a packet comprising message data during a reserved window of a communication interval at the first primary data rate; and
in response to an indication that the second device did not successfully receive the packet, retransmit the packet to the second device during a retransmission window of the communication interval at the first secondary data rate.

7. The method of claim 6, further comprising:
sending, via the transceiver of the first device, to the second device the packet during the reserved window of the communication interval at the first primary data rate; and
in response to the indication that the second device did not successfully receive the packet, retransmitting, via the transceiver of the first device, the packet to the second device during the retransmission window of the communication interval at the first secondary data rate.

8. The method of claim 7, further comprising:
in response to an indication that the second device did not successfully receive the retransmitted packet, retransmitting, via the transceiver of the first device, the packet to the second device during a second reserved window of the communication interval at the first primary data rate.

9. The method of claim 1, wherein negotiating, with the second device, comprises receiving an acknowledgement from the second device to indicate that the second device is capable of the dynamic data rate switching.

10. The method of claim 1, wherein in response to an indication that the second device is not capable of the dynamic data rate switching, not configuring the transceiver of the first device to operate with the dynamic data rate switching, and configuring the transceiver of the first device to operate at a static data rate.

11. The method of claim 10, further comprising receiving a message comprising a dynamic switching mode disable indication from the second device, the dynamic switching mode disable indication comprising the indication that the second device is not capable of the dynamic data rate switching.

12. A wireless device comprising:
at least one transceiver to transmit and receive radio frequency (RF) signals;
a baseband processor coupled to the at least one transceiver to process baseband signals, wherein the baseband processor is to operate a link manager of a logical link layer, wherein the link manager is to:
request a synchronous connection to be established between the wireless device and a second wireless device;
negotiate, with the second wireless device, parameters of the synchronous connection, the parameters comprising at least one dynamic data rate switching parameter; and
configure the at least one transceiver to operate with dynamic data rate switching based at least in part on the at least one dynamic data rate switching parameter and
a non-volatile memory coupled to the baseband processor to store code of the logical link layer.

13. The wireless device of claim 12, wherein the link manager is to send an extended synchronous connection oriented (eSCO) request to request the synchronous connection.

14. The wireless device of claim 13, wherein the link manager is to negotiate the at least one dynamic data rate switching parameter comprising:
a first primary data rate from the wireless device to the second wireless device;
a second primary data rate from the second wireless device to the wireless device;
a first secondary data rate from the wireless device to the second wireless device, wherein the first secondary data rate is less than the first primary data rate; and
a second secondary data rate from the second wireless device to the wireless device, the second secondary data rate less than the first secondary data rate.

15. The wireless device of claim 14, wherein the at least one transceiver is to:
send, to the second wireless device, a packet comprising message data during a reserved window of a first communication interval at the first primary data rate; and
receive, from the second wireless device, a response to the packet during the reserved window of the first communication interval.

16. The wireless device of claim 15, wherein the at least one transceiver is to:
when the response indicates that second wireless device successfully received the packet, send, to the second wireless device, a second packet comprising second message data during a reserved window of a second communication interval at the first primary data rate; and
when the response indicates that the second wireless device did not successfully receive the packet, retransmit, to the second wireless device, the packet during a retransmission window of the first communication interval at the first secondary data rate.

17. A non-transitory storage medium comprising instructions that when executed cause a first wireless device to perform a method comprising:
requesting a synchronous connection to be established between the first wireless device and a second wireless device;
negotiating, with the second wireless device, parameters of the synchronous connection, the parameters comprising at least one dynamic data rate switching parameter; and
configuring a transceiver of the first wireless device to operate with dynamic data rate switching based at least in part on the at least one dynamic data rate switching parameter.

18. The non-transitory storage medium of claim 17, wherein negotiating the at least one dynamic data rate switching parameter comprises negotiating:
a first primary data rate from the first wireless device to the second wireless device;
a second primary data rate from the second wireless device to the first wireless device;
a first secondary data rate from the first wireless device to the second wireless device, wherein the first secondary data rate is less than the first primary data rate; and
a second secondary data rate from the second wireless device to the first wireless device, the second secondary data rate less than the first secondary data rate.

19. The non-transitory storage medium of claim 18, wherein the method further comprises:
sending, via the transceiver of the first wireless device, to the second wireless device a packet comprising message data during a reserved window of a first communication interval at the first primary data rate; and
receiving, via the transceiver of the first wireless device, a response to the packet during the reserved window of the first communication interval.

20. The non-transitory storage medium of claim 17, wherein the method further comprises:
negotiating, with a third wireless device, parameters of another synchronous connection comprising a static data rate when the third wireless device does not support the dynamic data rate switching; and
configuring the transceiver of the first wireless device to operate with the static data rate when communicating with the third wireless device.
